(19) United States
(12) Patent Application Publication
(10) Pub. No.: US 2002/0000465 A1
(43) Pub. Date: Jan. 3, 2002

(54) DEVICE FOR MONITORING PARKED VEHICLES

(76) Inventor: TORBERNT HJELMVIK, JARFALLA (SE)

Correspondence Address: AGILENT TECHNOLOGIES, INC., INTELLECTUAL PROPERTY ADMINISTRATION, LEGAL DEPT., P.O. BOX 7599, M/S DL429, LOVELAND, CO, 80537-0599, US

(21) Appl. No.: 09/341,375

(22) PCT Filed: Jan. 8, 1998
(86) PCT No.: PCT/SE98/00008

(30) Foreign Application Priority Data
Jan. 10, 1997 (SE) 9700054-1

(51) Int. Cl. G07B 15/02

(52) U.S. Cl. 235/384

(57) ABSTRACT

A parking control unit intended primarily for checking whether a parking fee has been paid in respect of a parked vehicle. The parking control unit is intended for use in a parking system of a kind in which the user registers an account number and the vehicle registration number at the commencement of a parking period, and again registers the account number at the end of the parking period. The account number, the registration number, the parking commencement time, and the parking termination time are stored in the memory of a central computer so that the parking time that has elapsed between the parking commencement time and the parking termination time can be billed to the account number that was registered at the commencement of the parking period.

The present invention relates to a parking control unit for establishing whether or not a parking fee has been paid for parked vehicles.

Cities will normally have one or more vehicle parking companies who distribute parking meters, or so-called pay meters, throughout the city in a number of different places, of which streets and large ground-based parking areas are the most common.

In addition to coin payments, it has become increasingly common practice to pay a parking fee with a cash card of one kind or another. Card payments are made by drawing the cash card through a card reader on the pay meter.

The invention relates to the type of payment system with which the person parking a vehicle draws the cash card through a card reader in the pay meter and the pay meter stores the cash-card number and the time at which the card was read.

It is highly desirable to be able to use any parking meter whatsoever when parking a vehicle and then use any parking meter or pay meter whatsoever to pay the parking fee when collecting the vehicle. Thus, it should be possible to commence a series of parking occasions at one place in the city or town and draw the cash card through the reader of a given meter and to terminate the series of parking occasions at another place in the city or town, by drawing card through the reader of another meter.

One problem with the majority of known systems is that the pay meter must produce a parking ticket that contains machine-readable information and that each pay meter must have a reader that is able to read the ticket. This requires the pay meters to be serviced at relatively short intervals, in order to ensure the function of the meters. It is also necessary to replenish the pay meters with tickets.

Handling of the tickets can also be problematic. A lost ticket must be reported as being lost, in order to be able to terminate parking of the vehicle concerned.

A solution to this problem is described in Swedish Patent Specification No. 960112-7.

The invention according to this prior patent relates to a method of cash card billing by means of parking meters or pay meters when parking a vehicle, wherewith a system of pay meters includes several pay meters that are equipped with a cash card reader. A person parking a vehicle will initially look for a first pay meter and with the aid of the cash card reader enter information carried on the card, at least with respect to the card account number, wherewith the pay meter is caused to store the account number and the time at which parking commenced in a memory belonging to the pay meter, when reading the cash card. In conjunction with terminating parking of the vehicle, the cash card is inserted into another pay meter and read by the card reader of this meter, this latter pay meter optionally being any chosen pay meter in the pay meter system, including the pay meter first mentioned, wherewith the second pay meter is caused to store the account number together with the time at which the card was read, i.e. the parking terminating time, in a memory belonging to this second pay meter.

The invention according to this prior patent is characterized in that each pay meter has a keyboard by means of which a person can enter the registration number of the vehicle to be parked, in conjunction with causing the cash card to be read by the card meter at the commencement of parking the vehicle. The pay meter is caused to store the vehicle registration number together with the account number and the time at which parking commenced, and in that the memory of each pay meter is connected to the memory of a central computer; and in that billing is carried out on the account number carried on the cash card in question for the parking time that has lapsed between commencing and terminating parking of the vehicle.

According to one embodiment of this patent, the system of pay meters can be instructed to print-out or display those vehicle registration numbers that have commenced a parking period but have not terminated parking of the vehicle.

This instruction may, for instance, be given in a manner such that a car park attendant inserts a special authorization card in the card reader. The pay meter will be designed to print-out a list of vehicle registration numbers in alphabetical order with regard to those vehicles where parking has not been terminated. Alternatively, the registration numbers can be shown on a display in alphabetical order and the car park attendant can skim between registration numbers with the aid of arrow keys, for instance.

The car park superintendent can then compare the registration numbers of parked vehicles with numbers displayed or printed-out by the system. A vehicle whose registration number is not found in the system will be duly fined.

It will be understood that the system described in this prior patent specification is best suited for parking systems whose geographical extension is limited, such as multi-car parks or ground-based car parks. When the system is applied, for instance, over the whole city center, the lists will be very comprehensive and quickly out of date.

The present invention solves this problem and provides a very fast and effective parking control unit.

The present invention thus relates to a parking control unit which is intended primarily for checking whether or not a parking fee for a parked vehicle has been paid and which is intended for use in a parking system of the kind with which the user registers an account number and the vehicle registration number at the start of a parking period and again registers the account number at the time of terminating parking of the vehicle and wherewith the account number, the vehicle registration number, the parking starting time and the parking terminating time are stored in the memory of a central computer so that billing can be effected on the account number concerned for the parking time that has lapsed between the parking commencement time and the parking terminating time, and is characterized in that the parking control unit is portable and includes a display, a computer unit with an associated memory, and a communications unit adapted to communicate with the memory of the central computer to obtain information relating to the registration numbers of those vehicles which have commenced a parking period in the system but have not terminated parking of the vehicle; in that the parking control unit includes an optical image or picture reproducing device which functions to reproduce an image of the registration plates of vehicles and to clarify said numbers; and in that the parking control unit is adapted to compare the imaged and clarified registration number with those registration numbers o-f vehicles that have commenced a parking period but have not terminated parking in the system and to indicate, with the aid of indicating means whether or not a clarified registration number belongs to a vehicle that has commenced a parking period but where parking in the system has not been terminated.

The invention will now be described in more detail with reference to exemplifying embodiments thereof and also with reference to the accompanying drawings, in which

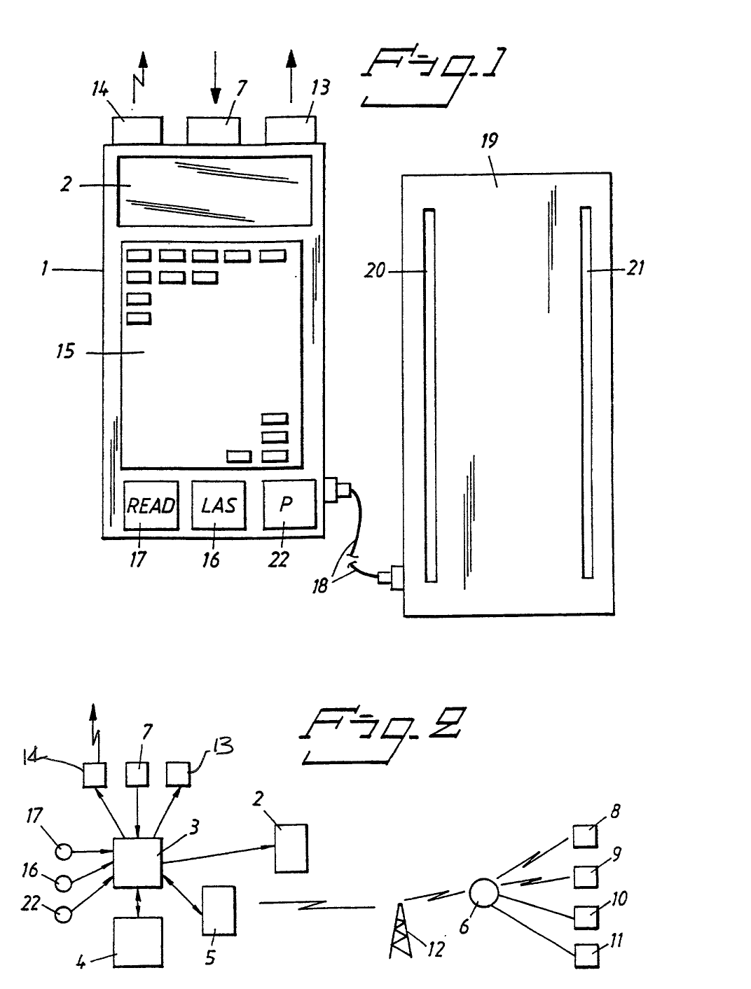

FIG. 1 illustrates a parking control unit constructed in accordance with the invention; and

FIG. 2 is a block schematic illustrating the parking control unit shown in FIG. 1 and its communication with the surroundings.

FIG. 1 illustrates a parking control unit which is primarily intended for checking whether or not a parking fee has been paid for a parked vehicle. The parking control unit is primarily intended for use in a parking system of a kind in which the user registers an account number and the vehicle registration number at the beginning of a parking period, and again registers the account number when parking is terminated.

The invention can be applied to particular benefit in a parking system constructed for cash card billing by means of pay meters when the parking system includes a plurality of pay meters belonging to a pay meter system. The pay meters are equipped with a cash card reader. A person parking his/her vehicle looks for a first pay meter when initially parking the vehicle and enters the cash-card account number by passing the card through the card reader, and then enters the registration number of the vehicle to be parked through the medium of a keyboard. The account number, vehicle registration number and the time at which parking was commenced is stored in a memory. When terminating parking of the vehicle, said person looks for a second pay meter and passes the cash card through the cash card reader of this second pay meter. The second pay meter may be any pay meter included in the pay meter system. The account number of the cash card is stored in the memory of this second pay meter together with the time at which the card was read, i.e. the parking termination time. Each pay meter is connected to the memory of a central computer, so that the parking time that has lapsed between the parking commencement time and the parking termination time can be billed to the account number concerned.

As an alternative to a cash card, any other means of payment or machine-readable identification of the person parking a vehicle can be used for billing the person concerned. In this case, devices other than generally conventional pay meters can be used to register vehicle registration numbers, debiting accounts, and vehicle parking commencement times and parking termination times. The main criterion in this respect is that the parking system obtains information as to the account to be debited and information relating to vehicle registration number, parking commencement time and parking termination time.

The inventive parking control unit is portable. For instance, the parking control unit may have a size corresponding to the size of a typical portable computer terminal. The parking control unit 1 includes a display 2, a computer unit 3 that includes a memory 4, and a communications unit 5 for communication with the memory of the central computer 6 for obtaining information relating to the registration numbers of those vehicles that have commenced a parking period in the parking system but have not as yet terminated parking. The parking control unit also includes an optical image reproducing device 7 which when aimed at a vehicle registration plate functions to reproduce and record an image of the registration plate and to clarify, that is to make clear, the vehicle registration number. The computer 3 of the parking control unit is adapted to compare the recorded and clarified registration number with the registration number of those vehicles that have begun a parking period but which have not terminated parking in the system, these numbers being stored in the memory 4.

The communications unit 5 is adapted to communicate with the central computer 6 via radio, preferably via a mobile telephone system, as illustrated with the mast 12. However, communication can, instead, be effected via a land-based network, where information is sent to the parking control unit with the aid of suitable terminals distributed at different sites in the parking area and connected to said unit. The terminals may, for instance, comprise pay meters.

FIG. 2 illustrates a number of pay meters 8-11 which deliver to the central computer 6 information relating to account number, vehicle registration number, parking commencement time and parking termination time. This transmission may be either a wireless transmission, as illustrated with the pay meters 8 and 9, or may be effected over a permanent network, as illustrated with the pay meters 10 and 11.

Ideally, the central computer will send to the parking control unit solely information relating to the registration numbers of those vehicles that have commenced a parking period but have not terminated parking. This information thus corresponds to a list of vehicles in the parking area.

According to one preferred embodiment of the invention, the parking control unit includes a low power laser adapted to act as a sighting means with which a parking attendant brings the parking control unit into alignment with the center part of the vehicle registration plate, whereafter the optical device 7 records an image of the registration plate.

The optical image reproducing device may be of the same kind as those used in digital cameras, i.e. include a so-called CCD element. Alternatively, a scanning laser may be used.

The optical signal received is clarified by the computer 3 with respect to the registration number, which is stored in the computer memory 4. This clarification of the registration number is effected in a known manner, by processing the signal arriving from the CCD element or the laser.

According to one preferred embodiment, the parking control unit is equipped with an illuminating device 14 which is adapted to illuminate the vehicle registration plates in conjunction with imaging said plates. This illuminating device may be a flood light or a camera-type flash unit. Ideally, the illuminating unit is activated automatically in the case of a low light level, as in the case of modern cameras.

According to one preferred embodiment, the parking control unit is equipped with a keyboard 15 by means of which a registration number can be entered manually.

The parking control unit is managed by the parking attendant, who presses a button 16 to activate the laser and then aims the laser beam onto the center of a vehicle registration plate. The parking attendant then presses a button 17 which activates the image reproducing device 7 so as to reproduce and record the registration plate. The imaged registration number is preferably presented on the display 2 so that the parking attendant is able to check that the registration plate was correctly reproduced.

According to the invention, the parking control unit is also adapted to disclose with the aid of an indicating device whether or not the registration number belongs to a vehicle that has commenced a parking period but not terminated parking in the system. Ideally, the indicating device will consist of said display and will suitably indicate only when the registration number reproduced by the image reproducing device 7 is not found in the computer member 4, meaning that the vehicle is parked illegally.

As will be understood, it is necessary to update the information in the memory 4 of the parking control unit continuously and at relatively short intervals. For instance, vehicle registration numbers will preferably be updated at one-minute intervals.

According to one especially preferred embodiment, the parking control unit can be connected by a cable 18 to a portable printer 19 for printing out parking fine tickets.

The printer 19 may be of any suitable kind. For instance, it may have a first slot 20 in which a blank parking-fine ticket is inserted and then fed through the printer while being printed and then dispensed via a second slot 21. The printer is small and portable.

When the indicating device on the parking control unit indicates that a vehicle is illegally parked, the parking attendant presses a button 22 so as to activate the printer and print-out a ticket on which at least the vehicle registration number is given.

On the other hand, the parking control unit may be in wireless connection via a telephone network with a motor vehicle registry that contains information relating to all vehicles in the country. The computer 3 may be programmed to collect via the communications unit information such as car model and color from the vehicle registry in respect of the vehicle whose registration plate has been read. This information can then be printed on the ticket.

According to another preferred embodiment, the image reproducing device 7 is adapted to enable a situation picture to be taken and stored in the memory 4 of the computer. This only requires the whole of the image received by a CCD element to be stored in the memory 4 in addition to the registration number. Such a situation image or picture may have the form of a typical photograph that shows the entire vehicle, or parts of the vehicle, and its position. These pictures or images can be transmitted from the parking control unit to the memory of the central computer 6 and later used as evidence. Naturally, a picture of the vehicle registration plate can be stored as evidence, instead of a situation picture.

As an alternative to printing-out a parking-fine ticket, the registration number and, when applicable, the situation picture can be stored in the memory 4 of the parking control unit and later transferred to a printer for print-out and dispatched by mail to the owner of the vehicle. The information can also be sent to the central computer 6 for further processing directly and by means of wireless transmission.

Although the invention has been described above with reference to a number of exemplifying embodiments thereof, it will be understood that the manner in which the information is transmitted and also the manner in which the registration number is recorded can be modified.

It will therefore be understood that the invention is not restricted to said exemplifying embodiment and that modifications and variations can be made within the scope of the following Claims.

1. A parking control unit intended primarily for checking whether or not a parking fee has been paid in respect of a parked vehicle, wherein the parking control unit is intended for use in a parking system of a kind in which the user registers an account number and the vehicle registration number at the commencement of a parking period and again registers the account number at the end of the parking period, and wherein the account number, the registration number, the parking commencement time and the parking termination time are stored in the memory of a central computer (6) so that the parking time that has lapsed between the parking commencement time and the parking termination time can be billed to the account number concerned, which parking control unit (1) is portable and includes a display (2), a computer unit (3) and associated memory (4), and a communication unit (5) adapted to communicate with the memory of said central computer (6) to obtain information relating to the registration numbers of those vehicles that have commenced a parking period in the parking system but have not terminated parking, characterized in that the parking control unit (1) includes an optical picture reproducing device (7) adapted to reproduce an image of the registration plate of a vehicle in that it includes a low-power laser (13) which functions as a sighting means by means of which the parking control unit (1) is brought into alignment with the center part of a vehicle registration plate by a parking attendant, whereafter recording of the registration plate takes place, and in that the parking control unit (1) is arranged to make clear or clarify said imaged registration number; and in that the parking control unit is adapted to compare the clarified registration number with those registration numbers of vehicles that have commenced a parking period but have not terminated parking in the system and to indicate through the medium of an indicator (2) whether or not the clarified registration number belongs to a vehicle that has commenced a parking period but has not terminated parking in the system.

2. A parking control unit according to claim 1, characterized in that the unit is equipped with an illuminating unit (14) which is adapted to illuminate the registration plate when reading said plate.

3. A parking control unit according to claim 1 or 2, characterized in that the unit is equipped with a keyboard (15) by means of which a vehicle registration number can be entered manually.

4. A parking control unit according to claim 1, 2 or 3 characterized in that said optical reproducing device is a camera unit (7) which enables a situation picture to be taken and stored electronically.

5. A parking control unit according to claim 1, 2, 3 or 4, characterized in that the unit can be connected to a portable printer (19) for printing-out a parking-fine ticket.

6. A parking control unit according to any one of the preceding Claims, characterized in that the unit is constructed to display information clarified by the camera unit (7) on said display (2).

7. A parking control unit according to any one of the preceding Claims, characterized in that the communication unit (5) is adapted to communicate with said central computer (6) via radio, preferably over a mobile telephone system.
